(19) United States
(12) Patent Application Publication
(10) Pub. No.: US 2024/0411514 A1
(43) Pub. Date: Dec. 12, 2024

(54) METHODS AND SYSTEMS FOR ADDITION, MULTIPLICATION, SUBTRACTION, AND DIVISION OF RATIONAL NUMBERS ENCODED IN THE DOMAIN OF FAREY RATIONALS FOR MPC SYSTEMS

(71) Applicant: Algemetric, Inc., Colorado Springs, CO (US)

(72) Inventors: David W. Honorio Araujo da Silva, Colorado Springs, CO (US); Luke E. Harmon, Colorado Springs, CO (US); Gaetan Delavignette, Colorado Springs, CO (US)

(73) Assignee: Algemetric, Inc., Colorado Springs, CO (US)

(21) Appl. No.: 18/739,306

(22) Filed: Jun. 10, 2024

Related U.S. Application Data
(60) Provisional application No. 63/471,940, filed on Jun. 8, 2023.

(51) Int. Cl. G06F 7/483

(52) U.S. Cl. CPC G06F 7/4836

(57) ABSTRACT

Disclosed are methods and systems to provide encoding and decoding using of p-adic arithmetic, and inverse p-adic arithmetic, in the domain of Farey rationals that is induced by a ring isomorphism, such that said encoded integers preserve inverses, and additive and multiplicative homomorphic properties. This encoding permits MPC systems to perform arithmetic more efficiently and accurately, particularly for division.

### CROSS REFERENCE TO RELATED APPLICATIONS

This application is a continuation-in-part of U.S. patent application Ser. No. 18/535,875, filed Dec. 11, 2023, entitled “Methods and Systems for P-Adic Encoding and Decoding of Rational Data for FHE Systems,” which was based upon and claimed the benefit of U.S. provisional application Ser. No. 63/386,700, filed Dec. 9, 2022, entitled “PIE p-adic Encoding for High-Precision Arithmetic in Homomorphic Encryption,” all of which are specifically incorporated herein by reference for all that they disclose and teach. This application is further based upon and claims the benefit of U.S. Provisional Application Ser. No. 63/471,940, filed Jun. 8, 2023, entitled “Mercury: Constant-Round Protocols for Multi-Party Computation with Rationals,” all of which is also specifically incorporated herein by reference for all that it discloses and teaches.

### BACKGROUND OF THE INVENTION

The advancement of science is possible when knowledge is shared and information is exchanged in a seamless manner. In a world where many businesses rely on information as their main assets, analysis over data is a crucial competitive advantage. Consequently, the amount of data processed and stored will continue to increase, creating a demand for virtualized services. To this end, some applications can be provided as cloud computing resources including Internet of Things (IoT), machine learning, virtual reality (VR) and blockchain. As a result, concerns about custody and privacy of data are on the rise.

Modern concealment/encryption employs mathematical techniques that manipulate positive integers or binary bits. Asymmetric concealment/encryption, such as RSA (Rivest-Shamir-Adleman), relies on number theoretic one-way functions that are predictably difficult to factor and can be made more difficult with an ever-increasing size of the encryption keys. Symmetric encryption, such as DES (Data Encryption Standard) and AES (Advanced Encryption Standard), uses bit manipulations within registers to shuffle the concealed text/cryptotext/ciphertext to increase “diffusion” as well as register-based operations with a shared key to increase “confusion.” Diffusion and confusion are measures for the increase in statistical entropy on the data payload being transmitted. The concepts of diffusion and confusion in encryption are normally attributed as first being identified by Claude Shannon in the 1940s. Diffusion is generally thought of as complicating the mathematical process of generating unencrypted (plain text) data from the encrypted (cryptotext/ciphertext) data, thus, making it difficult to discover the encryption key of the concealment/encryption process by spreading the influence of each piece of the unencrypted (plain) data across several pieces of the concealed/encrypted (cryptotext) data. Consequently, an encryption system that has a high degree of diffusion will typically change several characters of the concealed/encrypted (cryptotext/ciphertext) data for the change of a single character in the unencrypted (plain) data making it difficult for an attacker to identify changes in the unencrypted (plain) data. Confusion is generally thought of as obscuring the relationship between the unencrypted (plain) data and the concealed/encrypted (cryptotext) data. Accordingly, a concealment/encryption system that has a high degree of confusion would entail a process that drastically changes the unencrypted (plain) data into the concealed/encrypted (cryptotext/ciphertext) data in a way that, even when an attacker knows the operation of the concealment/encryption method (such as the public standards of RSA, DES, and/or AES), it is still difficult to deduce the encryption key.

Homomorphic Encryption is a form of encryption that allows computations to be carried out on concealed ciphertext as it is concealed/encrypted without decrypting the ciphertext that generates a concealed/encrypted result which, when decrypted, matches the result of operations performed on the unencrypted plaintext.

The word homomorphism comes from the ancient Greek language: óμóζ (homos) meaning “same” and μoρφ\acute{η} (morphe) meaning “form” or “shape.” Homomorphism may have different definitions depending on the field of use. In mathematics, for example, homomorphism may be considered a transformation of a first set into a second set where the relationship between the elements of the first set are preserved in the relationship of the elements of the second set. For instance, a map f between sets A and B is a homomorphism of A into B if

$$f ( {a}_{1} op {a}_{2} ) = f ( {a}_{1} ) op f ( {a}_{2} ) \vert {a}_{1} , {a}_{2} ∈ A$$

where “op” is the respective group operation defining the relationship between A and B.

More specifically, for abstract algebra, the term homomorphism may be a structure-preserving map between two algebraic structures such as groups, rings, or vector spaces. Isomorphisms, automorphisms, and endomorphisms are typically considered special types of homomorphisms. Among other more specific definitions of homomorphism, algebra homomorphism may be considered a homomorphism that preserves the algebra structure between two sets.

Multi-Party Computation (MPC) is a cryptographic technique that allows multiple parties to jointly compute a function over their private data without revealing it to each other. MPC works by using complex encryption to distribute computation between multiple parties. MPC enables parties to share data for computing tasks and obtain the output, but no party learns anything about others' data or secrets.

### SUMMARY OF THE INVENTION

An embodiment of the present invention may comprise a method for Multi-Party Computation (MPC) on a Multi-Party Computation (MPC) system of rational data encoded in a domain of Farey rationals, the method comprising: encoding by a first data server computing device a first rational number x₀/y₀ into a first encoded integer corresponding to the first rational number x₀/y₀ as an encode function of p-adic arithmetic in the domain of Farey rationals that is induced by a ring isomorphism performed on the first rational number x₀/y₀, such that the first encoded integer preserves inverses, and additive and multiplicative homomorphic properties; sending by the first data server computing device the first encoded integer to a third data server computing device; encoding by a second data server computing device a second rational number x₁/y₁ into a second encoded integer corresponding to the second rational number x₁/y₁ as the encode function of p-adic arithmetic in the domain of Farey rationals that is induced by a ring isomorphism performed on the second rational number x₁/y₁, such that the second encoded integer preserves inverses, and additive and multiplicative homomorphic properties; sending by the second first data server computing device the second encoded integer to the third data server computing device; computing by the third data server computing device an arithmetic function as part of the MPC system with the first encoded integer and the second encoded integer to obtain a result encoded integer; sending by the third data server computing device the result encoded integer to a fourth data server computing device; and decoding by the fourth data server computing device the result encoded integer into a result rational number xᵣ/yᵣ corresponding to the result encoded integer as a decode inverse function of p-adic arithmetic in the domain of Farey rationals performed on the result encoded integer.

An embodiment of the present invention may further comprise a Farey rational encoding system for Multi-Party Computation (MPC) on a Multi-Party Computation (MPC) system of rational data encoded in a domain of Farey rationals, the Farey rational encoding system comprising: a first data server computing system that encodes a first rational number x₀/y₀ into a first encoded integer corresponding to the first rational number x₀/y₀ as an encode function of p-adic arithmetic in the domain of Farey rationals that is induced by a ring isomorphism performed on the first rational number x₀/y₀, such that the first encoded integer preserves inverses, and additive and multiplicative homomorphic properties and sends the first encoded integer to a third data server computing device; a second data server computing device that encodes a second rational number x₁/y₁ into a second encoded integer corresponding to the second rational number x₁/y₁ as the encode function of p-adic arithmetic in the domain of Farey rationals that is induced by a ring isomorphism performed on the second rational number x₁/y₁, such that the second encoded integer preserves inverses, and additive and multiplicative homomorphic properties and sends the second encoded integer to the third data server computing device; the third data server computing device that computes an arithmetic function as part of the MPC system with the first encoded integer and the second encoded integer to obtain a result encoded integer and sends the result encoded integer to a fourth data server computing device; and the fourth data server computing device that decodes the result encoded integer into a result rational number x₁/y₁ corresponding to the result encoded integer as a decode inverse function of p-adic arithmetic in the domain of Farey rationals performed on the result encoded integer.

### BRIEF DESCRIPTION OF THE DRAWINGS

In the drawings,

FIG. 1 is a block diagram of the hardware implementation for an embodiment.

FIG. 2 is a flow chart of operations for an embodiment.

### DETAILED DESCRIPTION OF THE EMBODIMENTS

Secure computation has become a necessity in the modern world. Its applications are widespread: from allowing medical researchers to compute statistics over private patient data without violating HIPAA (Health Insurance Portability and Accountability Act) to helping large companies like Meta and Google avoid GDPR (General Data Protection Regulation) fines. A ubiquitous and popular choice for secure computation is Multi-Party Computation (MPC). Most MPC protocols work over finite fields or rings, which means that encoding techniques are required to map rational-valued data into the algebraic structure being used. The various embodiments herein leverage an encoding technique introduced in U.S. patent application Ser. No. 18/535,875, filed Dec. 11, 2023, entitled “Methods and Systems for P-Adic Encoding and Decoding of Rational Data for FHE Systems,” and are presented herein as Mercury-a family of protocols for addition, multiplication, subtraction, and division of rational numbers. Notably, the output of an embodiment's division protocol is exact (i.e., it does not use iterative methods). The protocols of the various embodiments offer significant improvements in both round complexity and communication complexity when compared with prior art, and are secure for a dishonest minority of semi-honest parties. To reiterate, the encoding technique of the various embodiments' protocols are based on is composable, so it can be paired with any MPC protocol over a prime-order field.

### 1 INTRODUCTION

Secure computation is a tool which allows functions of private data to be evaluated without revealing those data. One such tool is homomorphic encryption (HE), which allows, e.g., a data owner to encrypt their data and outsource computations on those data. More specifically, anyone can compute reasonable functions of the encrypted data and never learn more about the data than what the output of the function reveals. However, most HE schemes are prohibitively slow, especially when computing products. Further, most HE schemes, with the exception of CKKS (Cheon, Kim, Kim, and Song), do not support division. The CKKS scheme can perform division by approximating the inverse function with a Taylor polynomial T(x)≈x⁻¹ and then computing c₀/c₁≈c₀T(c₁), for ciphertexts c₀, c₁.

Another well-studied form of secure computation is Multi-Party Computation (MPC). In the classic setting, n mutually distrusting parties Pᵢ possess private data dᵢ and wish to jointly compute a function F(d₁, . . . , dₙ) without revealing dᵢ to Pⱼ for i≠j. Much work has been done extending these results, developing new tools for MPC, and implementing these tools in the real world. Many of these protocols rely on secret sharing. In secret sharing, each Pᵢ is provided masked pieces (called shares) of private data (henceforth, secrets). These shares are chosen such that only authorized sets of parties can determine a secret if they pool their shares. The parties use their shares to perform computations on the secrets by communicating (e.g., sending/receiving shares, creating and sending new shares, etc.) with one another as needed. A common primitive for secret sharing is Shamir's scheme, which is based on polynomial interpolation over a finite field. An advantage of the Shamir scheme is that it is additively homomorphic so that shares of two secrets can be added locally to give a sharing of the sum of those secrets. Additively homomorphic secret sharing is also used by the well-known MP-SPDZ framework.

Most MPC protocols are defined over finite rings or fields such as [symbol] /n [symbol] or GF (2^{l}), and as such require real data (often in the form of fixed-point or floating-point numbers) to be encoded as elements of the ring (field). Further, since the goal is evaluating certain functions (e.g., polynomials) over secret shared values, the encoding method must be homomorphic with respect to the operations which compose the function (e.g., addition and multiplication). Some works encode a fixed-point or floating-point number a with precision f as the integer a·2^{f}. Other approaches work with floating-point numbers by separately encoding the sign, exponent, and significand, along with an extra bit that is set to 0 if, and only if, the number is 0.

The various embodiments differ significantly from all of these approaches. Instead of choosing a set of fixed-point numbers and designing the protocols around them, the various embodiments start with a set of rationals (with bounded numerators and denominators) which can be constructed to contain a desired set of fixed-point numbers. This set of rationals, paired with an encoding that is homomorphic with respect to both addition and multiplication, forms the basis of the protocols of the various embodiments. The range of the encoding may be any ring/field of the form [symbol] /n [symbol] . This means that, for the most part, the protocols of the various embodiments are obtained by simply “attaching” the encoder to existing protocols. The exception is division which relies heavily on the structure of the aforementioned set of rationals.

The protocols of the various embodiments require only a constant number of rounds and have communication complexity O(tn), where n is the number of parties and t−1 is a bound on the number of corrupted parties. The protocols of the various embodiments are also generic, by which it is meant that the protocols do not depend on the underlying primitive being used. For example, even though the description of the various embodiments presented herein use Shamir's scheme as the example foundation, the protocols of the various embodiments for rational arithmetic could easily be translated to use additive secret sharing (e.g., implemented with MP-SPDZ). Moreover, the encoding technique on which the protocols of the various embodiments are based is composable, meaning that the encoding works with any MPC protocol based on secret sharing over a prime-order field.

### 2 PRELIMINARIES

### 2.1 Notation

For a positive integer a, [symbol] /a [symbol] denotes the ring of integers modulo a. In case a is prime, we write [symbol] a. The elements of [symbol] /a [symbol] will be represented by integers 0, 1, . . . , a−1. For a ring R, R[x] will denote the ring of polynomials with coefficients in R. We use y←A(x) to denote that a randomized algorithm A on input x outputs y. If A is deterministic, we simply write y=A(x). All circuits we consider are arithmetic over a field [symbol] ₐ, and have fan-in 2.

Shamir's scheme. Here is a brief overview of Shamir Secret Sharing (SSS), and the notation used therein. Suppose we have n parties and wish for any set of t≤n parties to be able to reconstruct a secret by pooling their shares. This is called t-out-of-n threshold scheme. One creates Shamir shares of a secret s∈ [symbol] ₚ by generating a random polynomial f(x)∈ [symbol] ₚ[x] of degree at most t−1 whose constant term is s (i.e., f(0)=s and whose remaining coefficients are chosen uniformly from [symbol] ₚ. Shares of s are the field elements f(i), i∈Fₚ\{0}. We assume the i^{th} party receives the share f(i). We use [x]ᵢ to denote the i^{th} party's share of x∈ [symbol] ₚ, and [x] to denote a sharing of x among all parties. Then, for example, [x]+[y] will mean “each party adds their share of x to their share of y,” and c[x] will mean “each party multiplies their share of x by c.” Any collection of t parties can pool their shares [s] and reconstruct the polynomial f using Lagrange interpolation, thereby obtaining the secret s=f(0).

### 2.1 Framework

As mentioned above, we use t-out-of-n SSS over [symbol] ₚ for all protocols. The various embodiment's protocols are built on the basic Shamir addition, and the multiplication introduced by Gennaro, Rabin and Rabin, which is itself an optimization of the multiplication described by Ben-Or, Goldwasser and Wigderson. To ensure the multiplication protocol works, the various embodiments require t−1<n/2. The various embodiments also tolerate up to t−1 semi-honest (honest-but-curious) adversaries. The communication complexity of a protocol is measured by the number of field elements sent by all parties throughout the protocol. When comparing with protocols that measure communication complexity in bits, the embodiments simply multiply its communication complexities by log₂(p).

### 3 PROTOCOLS FOR RATIONAL NUMBERS

A family of efficient MPC protocols for performing computations with rational numbers is proposed herein. These protocols are obtained by pairing an encoder that maps certain rational numbers to integers with the familiar SSS protocols for addition, multiplication, and computing modular inverses. The protocols for computing the sum and product of shared fixed-point numbers remain unchanged from the analogous SSS primitives, except that rational operands are encoded to field elements before any protocols are executed. Division is an amalgam of existing protocols and relies on the fact that the various embodiments' mapping for encoding rational numbers to integers is induced by a ring homomorphism, and therefore preserves inverses; likewise is true for the decode mapping. Further elaboration is given below.

### 3.1 Encoding Rationals

The various embodiments use the encoding map introduced in U.S. patent application Ser. No. 18/535,875, filed Dec. 11, 2023, entitled “Methods and Systems for P-Adic Encoding and Decoding of Rational Data for FHE Systems,” which maps a subset of rationals, whose denominators are co-prime with a prime p, into [symbol] ₚ using p-adic encoding and decoding supported by p-adic number theory. This map is defined by encode(x/y)=xy⁻¹ mod p, and has as its domain the Farey rationals:

$${N}_{} := \{ x / y : \vert x \vert \leq N , 0 < y \leq N , gcd ( x , y ) = 1 , gcd ( p , y ) = 1 \} ,$$

where N=N(p):=└\sqrt{(p−1)/2}┘. encode is induced by a ring isomorphism, so both it and its inverse decode are additively and multiplicatively homomorphic as long as the composition of operands in [symbol] _{N} remains in [symbol] _{N}

$$( e . g . , encode ( \frac{{x}_{0}}{{y}_{0}} + \frac{{x}_{1}}{{y}_{1}} ) = encode ( \frac{{x}_{0}}{{y}_{0}} ) + encode ( \frac{{x}_{1}}{{y}_{1}} ) iff \frac{{x}_{0}}{{y}_{0}} , \frac{{x}_{1}}{{y}_{1}} , \frac{{x}_{0}}{{y}_{0}} + \frac{{x}_{1}}{{y}_{1}} ∈ {N}_{} ) .$$

decode can be computed efficiently using a slight modification of the Extended Euclidean Algorithm. We summarize important properties of encode, decode, and [symbol] _{N} with the following lemma.

Lemma 1. Let p be a prime, N=N (p), and encode, decode be the encode and decode maps, respectively.
(i) If x/y∈ [symbol] _{N}, then −x/y∈ [symbol] _{N}.
(ii) If x/y∈ [symbol] _{N} is nonzero, then y/x∈ [symbol] _{N}.
(iii) [symbol] _{N} is not closed under addition and multiplication.
(iv) [−N, N]∩ [symbol] ⊆ [symbol] _{N}. Moreover, if [symbol] ∈[0, N]∩ [symbol] , then encode( [symbol] )= [symbol] .
(v) encode and decode are homomorphic with regard to addition and multiplication as long as the composition of operands in [symbol] _{N} remains in [symbol] _{N}.

Proof. (i)-(iv) are obvious.

For (v), the mapping Hₚ_{^{r}}: [symbol] _{N}→ [symbol] ₚ_{^{r}} and its inverse are defined as:

$${H}_{{p}^{r}} ( \frac{x}{y} ) = {xy}^{- 1} mod {p}^{r} ,$$

$${H}_{{p}^{r}}^{- 1} ( h ) = MEEA ( {p}^{r} , h ) .$$

The H-mapping is injective and, therefore, gives a unique representation of each element of [symbol] _{N} in [symbol] ₚ_{^{r}}. The inverse of Hₚ_{^{r}} is well-defined.

For all x/y∈ [symbol] _{N} and h∈Hₚ_{^{r}}( [symbol] _{N})⊆ [symbol] ₚ_{^{r}},

$${H}_{{p}^{r}}^{- 1} ( {H}_{{p}^{r}} ( x / y ) ) = x / y , \qquad ( i )$$

$${H}_{{p}^{r}} ( {H}_{{p}^{r}}^{- 1} ( h ) ) = h , \qquad ( ii )$$

$$If a , {a}^{′} ∈ ℤ and {a}^{′} = a ( mod {p}^{r} ) , then {H}_{{p}^{r}}^{- 1} ( a ) = {H}_{{p}^{r}}^{- 1} ( {a}^{′} ) \qquad ( iii )$$

The mappings Hₚ_{^{r}} and Hₚ_{^{r}}⁻¹ are homomorphic with respect to addition and multiplication in the following sense.

$$For all u , {u}^{′} ∈ {N}_{} , {H}_{{p}^{r}} ( u ) \cdot {H}_{{p}^{r}} ( {u}^{′} ) = {H}_{{p}^{r}} ( u \cdot {u}^{′} ) mod {p}^{r} and \qquad ( i )$$

$${H}_{{p}^{r}} ( u ) + {H}_{{p}^{r}} ( {u}^{′} ) = {H}_{{p}^{r}} ( u + {u}^{′} ) mod {p}^{r} .$$

$$If h , {h}^{′} ∈ {ℤ}_{{p}^{r}} and {H}_{{p}^{r}}^{- 1} ( h ) \cdot {H}_{{p}^{r}}^{- 1} ( {h}^{′} ) , {H}_{{p}^{r}}^{- 1} ( h ) + {H}_{{p}^{r}}^{- 1} ( {h}^{′} ) ∈ {N}_{} , then \qquad ( ii )$$

$${H}_{{p}^{r}}^{- 1} ( h \cdot {h}^{′} ) = {H}_{{p}^{r}}^{- 1} ( h ) \cdot {H}_{{p}^{r}}^{- 1} ( {h}^{′} ) and {H}_{{p}^{r}}^{- 1} ( h + {h}^{′} ) = {H}_{{p}^{r}}^{- 1} ( h ) + {H}_{{p}^{r}}^{- 1} ( {h}^{′} )$$

Proof. (i) Let a/b, c/d∈ [symbol] _{N}. By definition of the Farey rationals, a, b, c, d are co-prime with p. That Hₚ_{^{r}} is homomorphic with respect to addition and multiplication follows from the properties of congruences:

$${ac ( bd )}^{- 1} = ( {ab}^{- 1} ) ( {cd}^{- 1} ) mod {p}^{r} and$$

$$( ad + bc ) {( bd )}^{- 1} = ( {ab}^{- 1} + {cd}^{- 1} ) mod {p}^{r}$$

(ii) Invoking the homomorphic property of Hₚ_{^{r}}, from Hₚ_{^{r}}⁻¹(h)·Hₚ_{^{r}}⁻¹(h′), Hₚ_{^{r}}⁻¹(h)+Hₚ_{^{r}}⁻¹(h′)∈ [symbol] _{N} we obtain h·h′, h+h′∈Hₚ_{^{r}} ( [symbol] _{N}). By proposition 1(ii), Hₚ_{^{r}}(Hₚ_{^{r}}⁻¹(h·h′))=h·h′ and Hₚ_{^{r}} (Hₚ_{^{r}}⁻¹(h+h′))=h+h′. The result follows from the injectivity of Hₚ_{^{r}}.

### PIE: A Rational Encoder/Decoder

The encoding/decoding map introduced in U.S. patent application Ser. No. 18/535,875, is given as a PIE (p-adic encoding) rational encoder and decoder as described in more detail below.

Let g be a positive integer, N=└\sqrt{(g−1)/2}┘, and make [symbol] _{N} the input space. We define encoding and decoding as follows:
PIE.Encode(x/y). For x/y∈F_{N} output H_{g}(x/y)
PIE.Decode(z). For z∈ [symbol] _{g}, output H_{g}⁻¹(z)

For all m, m′∈ [symbol] _{N} such that m·m′∈ [symbol] _{N},

$$PIE . Decode ( [ PIE . Encode ( m ) \cdot PIE . Encode ( {m}^{′} ) mod g ] ) = m \cdot {m}^{′}$$

and ∀m, m′∈ [symbol] _{N} such that m+m′∈ [symbol] _{N}

$$PIE . Decode ( [ PIE . Encode ( m ) + PIE . Encode ( {m}^{′} ) mod g ] ) = m + {m}^{′}$$

Further, let p be a multivariate polynomial with coefficients in [symbol] . For all m₀, . . . , mₖ∈ [symbol] _{N} such that p(m₀, . . . , mₖ)∈ [symbol] _{N},

$$PIE . Decode ( g , p ( PIE . Encode ( g , {m}_{0} ) , … , PIE . Encode ( g , {m}_{k} ) ) mod g ) = p ( {m}_{0} , … , {m}_{k} ) .$$

For the encoding (and decoding) to yield the correct result when used in an MPC scheme, one must ensure that if two or more elements from [symbol] _{N} are combined using additions and/or multiplications then any intermediates and the final output must not lie outside the set [symbol] _{N}. For this reason, we will define the (rational) message space to be the following subset of [symbol] _{N}:

$${M}_{} = \{ x / y ∈ {N}_{} : 0 \leq \vert x \vert \leq M , 1 \leq y \leq M \}$$

The main idea behind choosing a subset of [symbol] _{N} as the set of messages is that when elements from [symbol] _{M} are combined, the resulting element can be in [symbol] _{N}. Ensuring the output lands in [symbol] _{N} induces a bound on the number of computations that can be performed, and determines the choice of parameters involved therein. At this point, one might wonder whether we need to do something similar with the range [symbol] _{g} of the encoder to make sure that overflow modulo g does not occur during computations. The answer is “no”. This is because proposition 3(iii) along with the above message space restriction imply that overflow modulo g does not affect decoding.

The choice of M depends jointly on the rational data one must encode, and the circuits one must evaluate over those data. We elaborate this in the following section.

Choosing the Message Space [symbol] _{M}.

We will describe an arithmetic circuit in terms of the multivariate polynomial it computes. To this end, recall that the [symbol] ₁-norm of a polynomial is simply the sum of the absolute values of its coefficients.

Polynomials with which PIE is compatible. Let [symbol] _{d,t} denote the set of polynomials in [symbol] [x₁, x₂, . . . ] with total degree at most d and [symbol] ₁-norm at most t, whose coefficients have absolute value at least 1. For example, [symbol] _{d,t} contains polynomials of the form:

$$p ( {x}_{1} , … , {x}_{k} ) = {\sum }_{{d}_{1} + … + {d}_{k} \leq d} {\sum }_{α = 1}^{I} {c}_{α} {x}_{1}^{{d}_{1}} {x}_{1}^{{d}_{2}} … {x}_{k}^{{d}_{k}} ,$$

where each |c_{α}|≥1, and Σ_{α}|c_{α}|≤t.

The following establishes an upper bound on the output of a polynomial in [symbol] _{d,t} when all inputs are from [symbol] _{M}.

If x₁/y₁, . . . , xₖ/yₖ ∈ [symbol] _{M}, p∈ [symbol] _{d,t} is k-variate, and p(x₁/y₁, . . . , xₖ/yₖ)=x/y, then:

|x|≤t·M^{dt} and |y|≤M^{dt}

Proof. Note that [symbol] _{d,t} can be written as, p=Σᵢcᵢpᵢ, where Σᵢ|cᵢ|≤t, each |cᵢ|≥1, and each pᵢ is a monomial of degree at most d.

Let p=Σᵢ₌₁^{l}cᵢpᵢ.

Since deg(pᵢ)≤d, the evaluation pᵢ(x₁/y₁, . . . , xₖ/yₖ) is a fraction of the form:

$$\frac{{a}_{i}}{{b}_{i}} = \frac{{x}_{{i}_{1}} {x}_{{i}_{2}} … {x}_{{i}_{ℓ}}}{{y}_{{i}_{1}} {y}_{{i}_{2}} … {y}_{{i}_{ℓ}}} , for some ℓ \leq d and \{ {i}_{1} , … , {i}_{ℓ} \} ⊆ \{ 1 , … , k \} .$$

As each xᵢ/yᵢ∈ [symbol] _{M}, we have |aᵢ|, |bᵢ|≤ [symbol] ≤M^{d}.

Since x/y=Σᵢ₌₁^{l}cᵢ·aᵢ/bᵢ, there are nonzero integers a and B such that:

$$α x = ( {c}_{1} {a}_{1} ) {b}_{2} {b}_{3} … {b}_{I} + {b}_{1} ( {c}_{2} {a}_{2} ) {b}_{3} … {b}_{I} + {b}_{1} {b}_{2} … {b}_{I - 1} ( {c}_{I} {a}_{I} )$$

$$and β y = {b}_{1} {b}_{2} … {b}_{I} .$$

It follows from Σ|cᵢ|≤t and the above bound on |aᵢ|, |bᵢ| that:

$$\vert x \vert \leq {\sum }_{i = 1}^{I} \vert {c}_{i} \vert {( {M}^{d} )}^{I} \leq t \cdot {M}^{dI} and \vert y \vert \leq {M}^{dI} .$$

The proof is completed by observing that |cᵢ|≥1, for all i, implies I≤t.

A sufficient condition for compatibility of PIE with polynomials in [symbol] _{d,t} as described above:

$$PIE . Decode ( g , p ( PIE . Encode ( g , {m}_{0} ) , … , PIE Enode ( g , {m}_{k} ) ) mod g ) = {pm}_{0} , … , {m}_{k} ) is$$

$$M \leq {( \frac{N}{t} )}^{\frac{1}{dt}} , equivalently d \leq \frac{log ( N ) - log ( t )}{t log ( M )} .$$

Proof. Suppose M is chosen according to the above equation, and let p∈ [symbol] _{d,t} be k-variate. According to the above descriptions, if m∉ [symbol] _{M}^{k} and p(m)=x/y, then:

$$\vert x \vert \leq t \cdot {M}^{dt} \leq t \cdot {( {( N / t )}^{\frac{1}{dt}} )}^{dt} = N , and$$

$$\vert y \vert \leq {M}^{dt} \leq ( {( N / t )}^{\frac{1}{dt}} ) = N / t \leq N .$$

Clearly gcd(g, y)=1, since y is a factor of the product of the denominators in m. Thus p(m)∈ [symbol] _{N}, and the proof is completed.

### 3.2 Building Blocks

SSS primitives will be the algorithms/protocols Share, Recon, Add, ScalarMult, and Mult. Respectively, these create shares of a secret value s∈ [symbol] ₚ, reconstruct a secret value given enough shares [s], compute the shares of the sum of two secrets without revealing either, compute shares of the product of a secret value and a known value without revealing the secret value, and compute shares of the product of two secrets without revealing either. Note that Recon, Add, and ScalarMult are all performed locally. By “performed locally” it is meant that the parties use their shares to execute the protocol without communicating with each other. For example, for Recon a party (or the dealer, if one exists) in possession of at least t shares reconstructs the secret using polynomial interpolation. s←Output([s]) is used to mean that each of a set of t−1 parties sends their share of s to another party, which subsequently computes s=Recon([s]) and sends s to the other n−1 parties. The Gennaro, Rabin and Rabin multiplication protocol is described below.

$$[ x y ] ← Mult ( [ x ] , [ y ] )$$

1. For i=1, . . . , n, the i^{th} party Pᵢ computes [symbol] ᵢ=[x]ᵢ·[y]ᵢ;
2. for i=1, . . . , 2t−1, Pᵢ computes [ [symbol] ᵢ]←Share( [symbol] ᵢ) (One could use any set of 2t−1 parties for this step);
3. once each party P₁, . . . , Pₙ has received 2t−1 shares, each party Pᵢ locally computes [xy]ᵢ using Lagrange interpolation on the received shares;
4. output [xy].

Two additional protocols, RandInt and Inv, are required for the rational division protocol of the various embodiments. These protocols allow all parties to obtain shares of a random ring element and compute shares of the multiplicative inverse of a ring element, respectively.

```
[r] ← RandInt( )
  1. Each of a set of t parties select a uniformly random
  rᵢ ∈ [symbol]   ₚ, i = 1,..., t;
  2. each of the t parties do [rᵢ] ← Share(rᵢ), and send the j^{th} share to Pⱼ;
  3. [r] ← Add([r₁],..., [rₜ]);
  4. return [r].
[x⁻¹] ← Inv([x])
  1. [r] ← RandInt( );
  2. [rx] ← Mult([r], [x]);
  3. rx = Output([rx]);
  4. abort and restart if rx = 0, otherwise continue;
  5. each party locally computes (rx)⁻¹ = x⁻¹r⁻¹ mod p;
  6. each party does [x⁻¹] = ScalarMult(x⁻¹r⁻¹, [r]);
  7. return [x⁻¹].
```

TABLE 1
Total communication complexity (measured in field
elements) of SSS building block protocols.

| Protocol | Rounds | Comm. Complexity |
|---|---|---|
| Share | 1 | n − 1 |
| Recon | 0 | 0 |
| Output | 2 | (n − 1) + (t − 1) |
| Add | 0 | 0 |
| Mult | 1 | (2t − 1)(n − 1) |
| ScalarMult | 0 | 0 |
| RandInt | 1 | t(n − 1) |
| Inv | 4 | t(3n − 2) − 1 |

Note that Share has communication complexity n (initial sharing of a secret), unless one party is sharing with the remaining parties, in which case it has communication complexity n−1. The latter is the only one relevant to our protocols.

### 3.3 Rational Addition, Multiplication, Subtraction, and Division

Addition and multiplication are obtained by simply pairing the encoder encode with Add and Mult. To represent shares of the encoding of x/y∈ [symbol] _{N}, we write [encode(x/y)]. We first present the four protocols, and then list their complexities in table 2. For all protocols, we use the field [symbol] ₚ, and

$$\frac{{x}_{o}}{{y}_{0}} , \frac{{x}_{1}}{{y}_{1}} ∈ {ℱ}_{N}$$

such that:

$$\frac{{x}_{0}}{{y}_{0}} \pm \frac{{x}_{1}}{{y}_{1}} , \frac{{x}_{0}}{{y}_{0}} \cdot \frac{{x}_{1}}{{y}_{1}} , \frac{{x}_{0}}{{y}_{0}} \div \frac{{x}_{1}}{{y}_{1}} ∈ {ℱ}_{N} .$$

Let t₀=encode(x₀/y₀) and t₁=encode(x₁/y₁).

Remark 1. We use the prefix “Hg” for our protocols because it is the chemical symbol for Mercury in the Periodic Table of Elements.

```
[encode(x₀/y₀ + x₁/y₁)] = HgAdd([encode(x₀/y₀)], [encode(x₁/y₁)])
  1. [t₀ + t₁] = Add([t₀], [t₁]);
  2. return [t₀ + t₁] = [encode(x₀/y₀ + x₁/y₁)].
[encode(x₀x₁/y₀y₁)] = HgMult([encode(x₀/y₀)], [encode(x₁/y₁)])
  1. [t₀t₁] ← Mult([t₀], [t₁]);
  2. return [t₀t₁] =[encode(x₀x₁/y₀y₁)].
[encode(x₀/y₀ − x₁/y₁)] = HgSubtr([encode(x₀/y₀)], [encode(x₁/y₁)])
  1. All parties compute encode(−1) = −1_{field} ∈ [symbol]   ₚ;
  2. all parties compute [−t₁] = ScalarMult(−1_{field}, [t₁]);
  3. [t₀ − t₁] = HgAdd([t₀], [−t₁]);
  4. return [t₀ − t₁] =[encode(x₀/y₀ − x₁/y₁)].
[encode(x₀y₁/y₀x₁)] = HgDiv([encode(x₀/y₀)], [encode(x₁/y₁)])
  1. [t₁⁻¹] ← Inv([t₁]);
  2. [t₀t₁⁻¹] ← HgMult([t₀], [t₁⁻¹]);
  3. return [t₀t₁⁻¹] =[encode(x₀y₁/y₀x₁)].
```

TABLE 2
Total communication complexity
(measured in field elements) of rational addition,
multiplication, subtraction, and division protocols.
Mercury

| Protocol | Rounds | Comm. Complexity |
|---|---|---|
| HgAdd | 0 | 0 |
| HgMult | 1 | (2t − 1)(n − 1) |
| HgSubtr | 0 | 0 |
| HgDiv | 5 | t(5n − 4) − n |

Remark 2. ScalarMult can be turned into HgScalarMult by simply encoding a public element α∈ [symbol] _{N}, and then computing [encode(α)s]=ScalarMult (encode(α), [s]). Note that HgScalarMult also serves as a division by public divisor protocol-simply replace α≠0 by 1/α.

### 4 WHICH RATIONAL NUMBERS CAN WE USE?

The various embodiments' protocols use the aforementioned Farey rationals. As mentioned in lemma 1 above, [symbol] _{N} is closed under additive inverses and under multiplicative inverses, but it is not closed under addition and multiplication. This means that a suitable subset of [symbol] _{N} must be chosen as the set of rational inputs. In particular, we must include fractions with “small” numerators and denominators so that adding/multiplying these fractions yields fractions that remain in [symbol] _{N}. Following closely the analysis of previously mentioned U.S. patent application Ser. No. 18/535,875, filed Dec. 11, 2023, entitled “Methods and Systems for P-Adic Encoding and Decoding of Rational Data for FHE Systems,” this set will be chosen as:

$${X , Y}_{} := \{ x / y ∈ {N}_{} \vert X , Y ∈ [ 0 , N ] , \vert x \vert \leq X , 0 < y \leq Y \} .$$

4.1 Compatibility with Fixed-Point Numbers

We now highlight the various embodiments' (partial) compatibility with fixed-point arithmetic. Further, many previous works designed their protocols with fixed-point arithmetic in mind. So, to facilitate comparison with prior art, we briefly discuss conditions under which [symbol] _{N} contains a set of fixed-point numbers.

Fixed-point numbers. These are rational numbers represented as a list of digits split by a radix point, and are defined by an integer (represented in a particular base b) in a given range along with a fixed scaling factor f. For example, we can represent decimal numbers with integral part in the range (− [symbol] , [symbol] ) and up to f decimal places after the radix point as a·10^{-f}=a/10^{f}, a∈(− [symbol] , [symbol] ). We will represent a set of fixed point numbers with a tuple of the form (b, [symbol] , f), where b is the base, ( [symbol] , [symbol] ) is range of the integer part, and up to f base-b digits are allowed after the radix point. The set of Farey rationals [symbol] _{N} contains the fixed-point numbers given by (b, [symbol] , f) as long as:

$$N \geq max \{ {b}^{ℓ + f + 1} - 1 , {b}^{f} - 1 \} . \qquad Eq . 1$$

Of course, N should be sufficiently large to ensure that adding/multiplying the fixed-point numbers does not cause overflow. While [symbol] _{N} can be made to contain a set of fixed-point numbers with precision f, addition and multiplication of Farey rationals does not quite coincide with addition and multiplication of fixed-point numbers. This is because the fixed-point representation requires the precision to remain f after each operation (this necessitates a truncation protocol), while [symbol] _{N} allows the precision to increase until overflow occurs and the output of a computation is no longer correct. However, this disparity mostly vanishes if the system running the protocols only allows precision f, because the “extra” bits that would be removed via a truncation protocol are removed by the system itself.

We will use the fact that [symbol] _{N} contains certain fixed-point numbers in Section 6 where we compare embodiments' protocols with prior work.

### 4.2 Compatible Circuits

Again borrowing from previously mentioned U.S. patent application Ser. No. 18/535,875, filed Dec. 11, 2023, entitled “Methods and Systems for P-Adic Encoding and Decoding of Rational Data for FHE Systems,” for positive integers d, t we define (d, t)-permitted (arithmetic) circuits over [symbol] to be those that compute a polynomial p∈ [symbol] [x₁, x₂, . . . ] such that: (i) p has [symbol] ₁ norm at most t, (ii) total degree at most d, and (iii) coefficients with absolute value greater than or equal to 1. Note that nonzero polynomials p∈ [symbol] [x₁, x₂, . . . ] with ∥p∥₁ and deg (p)≤d satisfy (iii). Let C_{d,t} be the set of (d, t)-permitted circuits, and [symbol] _{d,t} be the set of polynomials the circuits compute. The following lemma 2 is further described in U.S. patent application Ser. No. 18/535,875 at Proposition 7.

Lemma 2. Let C∈ [symbol] _{d,t} with inputs from [symbol] _{X,Y}⊆ [symbol] _{N}. If x/y is the output of C, then |x|≤tX^{d}Y^{d(t-1)} and |y|≤Y^{dt}.

Proof. This is a slight modification of the proof of U.S. patent application Ser. No. 18/535,875 at Proposition 7. The bounds given in lemma 2 allow us to determine the (d, t)-permitted circuits with output fractions in [symbol] _{N} given inputs from [symbol] _{X,Y}. Intuitively, the bound on x is larger than the bound on y because the numerator grows faster than the denominator when fractions are summed versus when they are multiplied. For example, (a/b)(c/d)=(ad/bc)/bd versus (a/b)(c/d)=ac/bd. Some “space” is wasted if, for example, one chooses X=Y, because then the numerator bound becomes the limiting factor for ensuring the output of a permitted circuit remains in [symbol] _{N}. For fixed d and t, this can be avoided by judiciously choosing X to be smaller than Y. In particular, X and Y should satisfy log₂(t)/d+log₂(X)=log₂(Y). Of course this is not possible for many applications, so typically the numerator bound will remain the limiting factor for depth of compatible circuits.

For example, suppose p is a prime such that N=└\sqrt{(p−1)/2}┘ is 1024 bits, and let X=2³², Y=2¹⁴. According to Lemma 2, we can only evaluate circuits in C^{d,t} with inputs in [symbol] _{X,Y} if t(2³²)^{d}(2¹⁴)^{d(t-1)}≤2¹⁰²⁴ or, equivalently, if log₂(t)+18d+14dt≤1024. Notice how the numerator bound from Lemma 2 is the only one needed to determine d and t. The following table shows some choices for d and t.

TABLE 3
Possible values of d (total degree of polynomial computed
by permitted circuit) and t ( [symbol] ₁ norm of polynomial
computed by permitted circuit) for fractions with
numerators bounded in absolute value by 2³² and
denominators bounded by 2¹⁴.
|num| ≤ 2³², denom = 2¹⁴

| d | 1 | 2 | 3 | 4 | 5 | 10 |
|---|---|---|---|---|---|---|
| t | 71 | 35 | 22 | 16 | 13 | 6 |

This is not particularly useful, as many applications require thousands or even millions of additions to be performed on shared values. However, for many applications one is likely to work with decimal numbers with a small number of significant digits; e.g., fractions with denominators a power of 10 between 7 bits and 17 bits. In such cases, we can significantly improve the bounds on d and t. In general, if the fractional data all have the same denominator, then Lemma 2 yields the following corollary.

Corollary 1. Let C∈ [symbol] _{d,t} with inputs from [symbol] _{N} whose denominators are all some power of integer base b>0, say B=b^{e}, and whose numerators are bounded in absolute value by X. If x/y is the output of C, then |x|≤t(XB)^{d} and y≤B^{d}.

Rehashing the above example (X=2³² and N 1024 bits) with B=2¹⁴ we get t(2³²2¹⁴)^{d}≤2¹⁰²⁴⇒log₂(t)≤1024−46d and (2¹⁴)^{d}≤2¹⁰²⁴⇒d≤73. The bound on d is in fact even smaller: since the [symbol] ₁ norm of a polynomial in [symbol] _{d,t} is at least 1, log₂(t)≥0⇒1024−46d≥0⇒22≥d. This yields the following table.

TABLE 4
Possible values of d (total degree of polynomial computed
by permitted circuit) and t ( [symbol] ₁ norm of polynomial
computed by permitted circuit) for fractions with
numerators bounded in absolute value by 2³² and
denominators bounded by 2¹⁴.
|num| ≤ 2³², denom = 2¹⁴

| d | 1 | 2 | 10 | 15 | 20 | 22 |
|---|---|---|---|---|---|---|
| t | 2⁹⁷⁸ | 2⁹³² | 2⁵⁶⁴ | 2³³⁴ | 2¹⁰⁴ | 2¹² |

So if we restrict inputs to have the same denominators, we can perform an enormous number of additions and a reasonable number of multiplications before the output lands outside of [symbol] _{N}. We can do even better though.

Degree-constant circuits. Each gate of an arithmetic circuit computes a polynomial over (some of) the inputs. We define a degree-constant (arithmetic) circuit to be one in which every gate computes a polynomial whose monomial summands all have the same degree; e.g., a dot product. The goal of introducing these circuits is to ensure that whenever two fractions are summed, they already have a common denominator.

Corollary 2. Let C∈ [symbol] _{d,t} be degree-constant with inputs from [symbol] _{N} whose denominators are all B=b^{e} and whose numerators are bounded in absolute value by X>0. If x/y is the output of C, then |x|≤tX^{d} and y≤B^{d}.

Proof. This follows easily from the fact that whenever two terms are added during the evaluation of a degree-constant circuit, they already have a common denominator which is a power of B.

Again, using a 1024 bit N, X=2³², and B=2¹⁴, we get the inequalities log₂(t)≤1024−32d and d≤32, yielding the following table.

TABLE 5
Possible values of d (total degree of polynomial computed
by a permitted circuit) and t ( [symbol] ₁ norm of polynomial
computed by permitted circuit) for degree- constant C ∈ [symbol] _{d, t}
taking inputs from F_{N} with numerators bounded in
absolute value by 2³² and denominators all
equal to 2¹⁴.
|num| ≤ 2³², denom = 2¹⁴

| d | 1 | 2 | 10 | 15 | 25 | 31 |
|---|---|---|---|---|---|---|
| t | 2⁹⁹² | 2⁹⁶⁰ | 2⁷⁰⁴ | 2⁵⁴⁴ | 2³⁸⁴ | 2³² |

Incorporating division. Once we allow divisions, the bounds given in Corollary 1 and Corollary 2 no longer apply, since the numerator of the divisor becomes a factor of denominator of the quotient. This means we should perform any necessary divisions as late as possible relative to other operations.

### 5 OPTIMIZATIONS

The complexity of HgMult and HgDiv can be reduced by executing parts of the protocols asynchronously in an offline phase. This allows certain parts of the protocols to be executed before the desired computation, thereby reducing the online complexity. The complexity of the offline phase depends on chosen primitives, existence of a trusted dealer, etc. Henceforth, we emphasize the online round complexity and the online communication complexity.

We utilize two ubiquitous tools for optimization: Beaver triples (introduced in [3]) for more efficient multiplication, and Pseudo-Random Secret Sharing (PRSS, [11]) to generate random field elements sans interaction.

In PRSS, the parties agree on a pseudo-random function (PRF) ψ·(·) and a common input a. They then use pre-distributed keys r_{A} (one for each set A of n−t parties) to locally compute shares of a random field element s using Replicated Secret Sharing (see for details). The use of PRSS reduces the online round and communication complexity of RandInt from 1 and t(n−1) to 0 and 0, respectively. Further, we assume that the PRF, common input, and keys are agreed upon and distributed during a set-up phase, whence using PRSS makes the offline round and communication complexity of RandInt both 0.

Beaver triples are 3-tuples of shares ([a], [b], [c]) satisfying ab=c, and can be generated asynchronously in the offline phase using PRSS and Mult. These triples can be used to multiply secrets without interaction. In particular, shares [xy] can be obtained from [x] and [y] using only Add, ScalarMult, Recon, Output, and one Beaver triple ([a], [b], [c]):

$$[ x y ] = ( x + a ) [ y ] - ( y + b ) [ a ] + [ c ] .$$

Used triples must be discarded, else information is leaked. This means that a sufficiently-large reservoir of Beaver triples should be maintained to allow the desired functions to be computed.

These optimizations reduce the online complexities of HgMult and HgDiv, and leave the complexities of HgSubtr and HgAdd the same. Table 6 below summarizes the improvements.

TABLE 6
Optimized round and communication complexities for our protocols.
Note that the nonzero offline communication complexities
come from Mult during Beaver triple generation.

| | Online | Offline | | |
|---|---|---|---|---|
| Protocol | Rounds | Rounds | Online Comm. | Offline Comm. |
| HgAdd | 0 | 0 | 0 | 0 |
| HgMult | 0 | 0 | 0 | (2t − 1)(n − 1) |
| HgSubtr | 0 | 0 | 0 | 0 |
| HgDiv | 2 | 2 | (t − 1) + (n − 1) | 2(2t − 1)(n − 1) |

We use the complexities listed in table 6 for the comparisons in section 6. Henceforth, “rounds” will mean “online rounds+offline rounds”, and “total communication” will mean “online communication+offline communication”.

### 6 COMPARISON WITH PRIOR WORK

Catrina and Saxena introduced semi-honest secure protocols for fixed-point multiplication and division—their division is based on (the iterative) Goldschmidt's method. A variant of their protocol is used by MP-SPDZ for fixed-point division. Catrina subsequently improved the round and communication complexities. To measure the complexities of their protocols, they use the set of fixed-point numbers given by (2, 2f, f); i.e., the set of rationals a·2^{-f} with a∈[−2^{-2f}, 2^{2f})∩ [symbol] . Their fixed-point encoding technique requires a field [symbol] _{q} with q>2^{2f+κ}, κ a statistical security parameter. For our protocols, we use the same field [symbol] _{q}, whence our set of rationals is [symbol] _{N} with N=N(q); specifically log₂(N)≥f+κ/2. Table 7 shows that for reasonable values of n and t (e.g., n=3, t=2), our protocols far outperform those of Catrina's subsequent improvements.

TABLE 7
Complexity comparison between our work and that of [7]
Both the online and offline communication complexity are measured
in elements of [symbol] g sent among all parties throughout
a protocol. n and t are the number of parties and the threshold,
resp., θ is the number of iterations of Goldschmidt's
method, and f is the fixed-point precision.

| | Protocol | Rounds | Online Comm. | Offline Comm. |
|---|---|---|---|---|
| Mercury | Multiplication | 0 | 0 | (2t − 1)(n − 1) |
| | Division | 3 | (t − 1) + | 2(2t − 1)(n − 1) |
| | | | (n − 1) | |
| [7] | Multiplication | 1 | 1 | f |
| | Division | 9 + θ | 10f + 2θ | 16f + 4θf |

For example, the authors suggest f=32 and θ=5, which results in a 14 round division with online communication complexity 320 field elements. Taking n=3 and t=2, our division requires 2 rounds, and has online communication complexity 3 field elements. There is, however, a bit more subtlety to this comparison. As mentioned in Section 4.1, operations on fixed-point numbers require a truncation, and the protocols of Catrina et al. use truncation. Consequently, there is no limit to how many times they can multiply/divide two fixed-point numbers. However, there is a number of multiplications, say, that will render their outputs of little use because so many bits have been truncated. Our limitation, on the other hand, is overflow: computations over [symbol] _{N} are only meaningful if all intermediate outputs and the final output are in [symbol] _{N}. We can address this in two ways: (i) only take inputs from the subset [symbol] _{X,Y}⊆ [symbol] _{N} defined in section 4, for X, Y sufficiently smaller than N, or (ii) use a larger field than Catrina. As long as we don't choose too large a field, (ii) will preserve our complexity advantage.

Another interesting solution, albeit only for integer division, was proposed by Veugen and Abspoel. They propose three division variations: public divisor, private divisor (only one party knows the divisor), and secret divisor (hidden from all parties). Their protocols are implemented using MP-SPDZ with three parties, and runtimes along with communication complexities (in MB) for dividing a k-bit integer by a k/2-bit integer are provided. Even though our division protocol uses rationals in general, comparison makes sense because [symbol] _{N} contains the integers [−N, N]∩ [symbol] (see lemma 1). For comparison, we use n=3 and t=2, and use the smallest prime field [symbol] ₚ allowed by Veugen and Abspoel:

$${log}_{2} ( p ) \approx 4 max \{ {log}_{2} ( dividend ) , {log}_{2} ( divisor ) \} + 40$$

For example, this means that for a 64 bit dividend and 32 bit divisor, we have log₂(p)=296 and N=N(p)≈148 bits.

The reader should take the comparison in table 8 with a grain of salt since our numbers were estimated and not obtained from implementation.

TABLE 8
Total communication complexity in megabytes (MB) of our division protocol (applied
to integers) vs. the (secret divisor) integer division protocol of Veugen and Abspoel.
The communication complexities for our work were estimated using table 7.

| dividend bits | 8 | | 16 | | 32 | | 64 | |
|---|---|---|---|---|---|---|---|---|
| divisor bits | 4 | | 8 | | 16 | | 32 | |
| Mercury | 0.001 | MB | 0.0015 | MB | 0.0024 | MB | 0.0042 | MB |
| [20] (semi-honest | 8.6 | MB | 32.6 | MB | 121.0 | MB | 492.7 | MB |

security)

The last comparison we shall show is against Pika. Pika uses Function Secret Sharing to construct a three-party protocol (one party is used only to generate correlated randomness) for computing functions such as reciprocal, sigmoid, and square root. The protocol Pika takes as inputs (binary) fixed-point numbers x with precision f, such that x·2^{f}∈(−2^{k-1}, 2^{k-1}], and creates shares in the ring [symbol] , where [symbol] ≥2 k. For comparison, we choose N=N(p)=2^{k-1} (meaning we share secrets over [symbol] ₚ with p≈2^{2k}). This guarantees that [symbol] _{N} contains the fixed-point numbers used by Pika regardless of the chosen precision f. As with the preceding comparisons, we again take n=3 and t=2.

Using the same parameter values for (semi-honest secure) Pika as the author, we found that that total communication complexity for securely computing the reciprocal with k=16 and [symbol] =32 was 8524 bits over three rounds (one offline). In contrast, we can compute the reciprocal of an element of [symbol] ₂_{¹⁵} in three rounds (one offline) with communication complexity 9 log₂(p)≈18 k=288 bits.

### 7 CONCLUSIONS

Conclusion. This work uses Shamir Secret Sharing with a minority of semi-honest adversaries, but Mercury is flexible in the sense that it can be easily realized over other primitives with better security assumptions; e.g. additive secret sharing à la MP-SPDZ along with a majority of malicious adversaries. Mercury provides an efficient low round and communication complexity solution to exact computation over rational numbers using MPC. A cost of exactness, though, is that our protocols are not intrinsically compatible with fixed-point arithmetic. Instead of truncating after every operation to not exceed the chosen fixed-point precision, we allow the precision to grow until overflow occurs. This means that we may need to work over a larger field [symbol] ₚ than prior art, but our communication and round complexity are sufficiently low as to make using a slightly larger field not problematic.

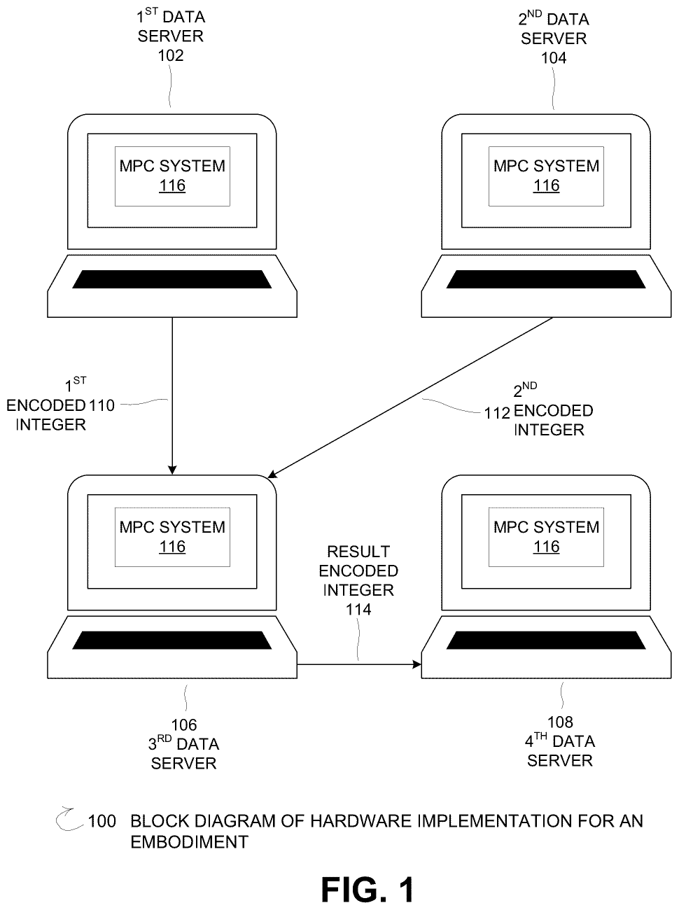

### Hardware Implementation for an Embodiment (FIG. 1)

FIG. 1 is a block diagram 100 of the hardware implementation for an embodiment. A 1^{st} data server computing device 102 is connected over an electronic network/bus connection 110 to 3^{rd} data server computing device 106. A 2^{nd} data server computing device 104 is also connected over an electronic network/bus connection 112 to the 3^{rd} data server computing device 106. The third data server computing device 106 is further connected over an electronic network/bus connection 114 to the 4^{th} data server computing device 108.

In the embodiment shown in FIG. 1, the 1^{st} data server computing device 102 acts as the source of the 1^{st} encoded integer 110 and the 1^{st} data server computing device 102 sends the 1^{st} encoded integer 110 over the network/bus connection 110 to the 3^{rd} data server computing device 106. The 2^{nd} data server computing device 104 acts as the source of the 2^{nd} encoded integer 112 and the 2^{nd} data server computing device 104 sends the 2^{nd} encoded integer 112 over the network/bus connection 112 to the 3^{rd} data server computing device 106.

The 3^{rd} data server computing device 106, in compliance with the MPC system 116, performs an arithmetic operation (addition, subtraction, multiplication, and/or division) with the 1^{st} encoded integer 110 and the 2^{nd} encoded integer 112. The 3^{rd} data server computing device 106 then sends the result encoded integer 114 over the network/bus connection 114 to the 4^{th} data server computing device 108. The 4^{th} data server computing device 108 then decodes the result encoded integer 114.

The 1^{st} encoded integer 110 and the 2^{nd} encoded integer 112 starts at the source computing device as one or more rational numbers (e.g., of the form x/y). An embodiment at the 1^{st} data server computing device 102 and the 2^{nd} data server computing device 104 encodes the rational numbers into corresponding 1^{st} encoded integer 110 and the 2^{nd} encoded integer 112, respectively as a function of p-adic arithmetic performed on the rational numbers.

Generally, communications, including concealed/encrypted communications, are bi-directional and may be connected between any of the data server computing devices 102-108, such that data server computing devices 102-108 may change roles as is necessary to accommodate the transfer of data back and forth between the data server computing devices 102-108. Additionally, while the data server computing devices 102-108 are depicted as separate devices in FIG. 1, the functionality of the data server computing devices 102-108 may be shared on a single computing system/device or among two or more computing devices.

Further, as shown in FIG. 1, the data server computing devices 102-108 appear to be laptop computers, but any computing device or system may be satisfactory. Generally, any computing device capable of communication over any form of electronic network or bus communication platform may be one or more of the data server computing devices 102-108. Additionally, data server computing devices 102-108 may actually be the same physical computing device communicating over an internal bus connection with itself.

Various embodiments may implement the network/bus communications channel 110-114 using any communications channel 110-114 capable of transferring electronic data between the data server computing devices 102-108. For instance, the network/bus communication connection 110-114 may be an Internet connection routed over one or more different communications channels. Likewise, the network/bus communication connection 110-114 may be an internal communications bus of a computing device, or even the internal bus of a processing or memory storage Integrated Circuit (IC) chip, such as a memory chip or a Central Processing Unit (CPU) chip. The network/bus communication channel 110-114 may utilize any medium capable of transmitting electronic data communications, including, but not limited to: wired communications, wireless electro-magnetic communications, fiber-optic cable communications, light/laser communications, sonic/sound communications, etc., and any combination thereof of the various communication channels.

The T various embodiments may provide the control and management functions detailed herein via an application operating on the data server computing devices 102-108. The data server computing devices 102-108 may each be a computer or computer system, or any other electronic devices capable of performing the communications and computations of an embodiment. The data server computing devices 102-108 may include, but are not limited to: a general-purpose computer, a laptop/portable computer, a tablet device, a smart phone, an industrial control computer, a data storage system controller, a CPU, a Graphical Processing Unit (GPU), an Application Specific Integrated Circuit (ASIC), and/or a Field Programmable Gate Array (FPGA). Notably, the data server computing devices 102-108 may be the storage controller of a data storage media (e.g., the controller for a hard disk drive). Embodiments may be provided as a computer program product which may include a computer-readable, or machine-readable, medium having stored thereon instructions which may be used to program/operate a computer (or other electronic devices) or computer system to perform a process or processes in accordance with the various embodiments. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

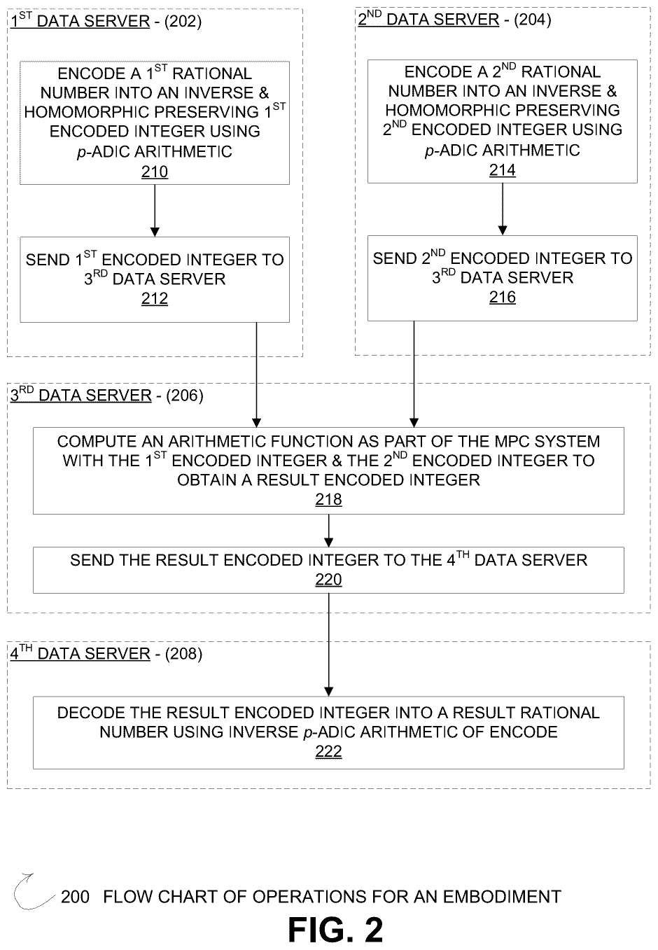

### Operational Flow Chart for an Embodiment (FIG. 2)

FIG. 2 is a flow chart 200 of operations for an embodiment. At process 210, the 1^{st} data server computing device 202 encodes a 1^{st} rational number (e.g., x₀/y₀) into a 1^{st} corresponding encoded integer using p-adic arithmetic that provides the inverse and homomorphic preserving aspects of the p-adic generated integers. At process 212, the 1^{st} data server computing device 202 sends 1^{st} encoded integer to the 3^{rd} data server computing device 206. At process 214, the 2^{nd} data server computing device 204 encodes a 2^{nd} rational number (e.g., x₁/y₁) into a 2^{nd} corresponding encoded integer using p-adic arithmetic that provides the inverse and homomorphic preserving aspects of the p-adic generated integers. At process 216, the 1^{st} data server computing device 202 sends 1^{st} encoded integer to the 3^{rd} data server computing device 206. At process 218, the 3^{rd} data server computing device 205, in accord with the MPC system, computes an arithmetic function with the 1^{st} encoded integer and 2^{nd} encoded integer in to obtain at least one result encoded integer. The potential arithmetic functions are one or more of addition, subtraction, multiplication, and division. At process 220, the 3^{rd} data server computing device 206 sends the result encoded integer to the 4^{th} data server computing device 208. At process 222, the 4^{th} data server computing device decodes the result encoded integer into a corresponding result rational number (e.g., xᵣ/yᵣ) using inverse p-adic arithmetic. The MPC system running on the data server computing devices 202-208 should be of the same type.

Additionally, while the flow charts and flow chart details described above with respect to FIG. 2 describe a methodology that may be embodied as a method or process, another embodiment may be recognized as a computer system, and/or as an intermediary computing device that stores and/or performs homomorphic operations of encrypted data by implementing the processes described above with respect to the flow chart and flow chart details of FIG. 2. Further, in describing the computing system, and/or the intermediary computing system, one, or more, individual processes described above for the methodology may be broken down and represented as a subsystem of the overall encryption computer system. A subsystem of the computer system, in whole or in part, may be assigned to a particular hardware implemented system, such as a dedicated Application Specific Integrated Circuit (ASIC) or Field Programmable Gate Array (FPGA). One or more subsystems, in whole or in part, may alternatively be implemented as software or firmware instructions defining the operation of a computer system with specific regard to the one or more subsystems implemented as software or firmware instructions. The software or firmware instructions may cause the Central Processing Unit, memory, and/or other systems of a computer system to operate in particular accordance with the particular one or more subsystems designated features.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated.

What is claimed is:

1. A method for Multi-Party Computation (MPC) on a Multi-Party Computation (MPC) system of rational data encoded in a domain of Farey rationals, the method comprising:
encoding by a first data server computing device a first rational number x₀/y₀ into a first encoded integer corresponding to said first rational number x₀/y₀ as an encode function of p-adic arithmetic in said domain of Farey rationals that is induced by a ring isomorphism performed on said first rational number x₀/y₀, such that said first encoded integer preserves inverses, and additive and multiplicative homomorphic properties;
sending by said first data server computing device said first encoded integer to a third data server computing device;
encoding by a second data server computing device a second rational number x₁/y₁ into a second encoded integer corresponding to said second rational number x₁/y₁ as said encode function of p-adic arithmetic in said domain of Farey rationals that is induced by a ring isomorphism performed on said second rational number x₁/y₁, such that said second encoded integer preserves inverses, and additive and multiplicative homomorphic properties;
sending by said second first data server computing device said second encoded integer to said third data server computing device;
computing by said third data server computing device an arithmetic function as part of said MPC system with said first encoded integer and said second encoded integer to obtain a result encoded integer;
sending by said third data server computing device said result encoded integer to a fourth data server computing device; and
decoding by said fourth data server computing device said result encoded integer into a result rational number x₁/y₁ corresponding to said result encoded integer as a decode inverse function of p-adic arithmetic in said domain of Farey rationals performed on said result encoded integer.

2. The method of claim 1 wherein said arithmetic function is addition performed according to the MPC system functions.

3. The method of claim 1 wherein said arithmetic function is subtraction performed according to the MPC system functions.

4. The method of claim 1 wherein said arithmetic function is division performed by inverting said second encoded integer and multiplying according to the MPC system functions by said first encoded integer to obtain said result encoded integer of said 1^{st} encoded integer divided by said second encoded integer.

5. An Farey rational encoding system for Multi-Party Computation (MPC) on a Multi-Party Computation (MPC) system of rational data encoded in a domain of Farey rationals, the Farey rational encoding system comprising:
a first data server computing system that encodes a first rational number x₀/y₀ into a first encoded integer corresponding to said first rational number x₀/y₀ as an encode function of p-adic arithmetic in said domain of Farey rationals that is induced by a ring isomorphism performed on said first rational number x₀/y₀, such that said first encoded integer preserves inverses, and additive and multiplicative homomorphic properties and sends said first encoded integer to a third data server computing device;
a second data server computing device that encodes a second rational number x₁/y₁ into a second encoded integer corresponding to said second rational number x₁/y₁ as said encode function of p-adic arithmetic in said domain of Farey rationals that is induced by a ring isomorphism performed on said second rational number x₁/y₁, such that said second encoded integer preserves inverses, and additive and multiplicative homomorphic properties and sends said second encoded integer to said third data server computing device;
said third data server computing device that computes an arithmetic function as part of said MPC system with said first encoded integer and said second encoded integer to obtain a result encoded integer and sends said result encoded integer to a fourth data server computing device; and
said fourth data server computing device that decodes said result encoded integer into a result rational number xᵣ/yᵣ corresponding to said result encoded integer as a decode inverse function of p-adic arithmetic in said domain of Farey rationals performed on said result encoded integer.

6. The Farey rational encoding system of claim 5 wherein said arithmetic function is addition performed according to the MPC system functions.

7. The Farey rational encoding system of claim 5 wherein said arithmetic function is subtraction performed according to the MPC system functions.

8. The Farey rational encoding system of claim 5 wherein said arithmetic function is division performed by inverting said second encoded integer and multiplying according to the MPC system functions by said first encoded integer to obtain said result encoded integer of said 1^{st} encoded integer divided by said second encoded integer.
